(19) United States
(12) Patent Application Publication
(10) Pub. No.: US 2018/0164910 A1
(43) Pub. Date: Jun. 14, 2018

(54) WIDE TOUCHPAD

(71) Applicant: Lenovo (Singapore) Pte. Ltd., Singapore (SG)

(72) Inventor: Ali Kathryn Ent, Raleigh, NC (US)

(21) Appl. No.: 15/373,401

(22) Filed: Dec. 8, 2016

(51) Int. Cl. G06F 3/0354; G06F 1/16; G06F 3/02; G06F 3/023; G06F 3/01; G06F 3/0488

(52) U.S. Cl. CPC G06F 3/03547; G06F 1/1681; G06F 3/0219; G06F 2203/04808; G06F 3/018; G06F 3/04883; G06F 1/1618; G06F 3/0233

(57) ABSTRACT

An apparatus can include a processor; memory accessible by the processor; and a display housing, a keyboard housing and a hinge assembly that rotatably couples the display housing and the keyboard housing where the keyboard housing includes a hinge assembly end, a front end, a left side and a right side; a keyboard that includes a spacebar, an S key, an L key and an S-to-L key distance; and a touchpad disposed between the spacebar and the front end that extends a left side to right side distance greater than the S-to-L key distance.

### TECHNICAL FIELD

Subject matter disclosed herein generally relates to technologies and techniques associated with touchpads.

### BACKGROUND

Touchpads find use with a variety of systems such as notebook (or laptop) computers, netbooks, etc. As an example, consider a notebook computer that includes a display mounted in one portion and a keyboard and a touchpad mounted in another portion where the two portions are connected, for example, via a hinge or hinges. While such a system may include a separate mouse as a pointing device, inclusion of a touchpad provides for more compactness and portability of the notebook computer.

### SUMMARY

An apparatus can include a processor; memory accessible by the processor; and a display housing, a keyboard housing and a hinge assembly that rotatably couples the display housing and the keyboard housing where the keyboard housing includes a hinge assembly end, a front end, a left side and a right side; a keyboard that includes a spacebar, an S key, an L key and an S-to-L key distance; and a touchpad disposed between the spacebar and the front end that extends a left side to right side distance greater than the S-to-L key distance. Various other devices, systems, methods, etc., are also disclosed.

### BRIEF DESCRIPTION OF THE DRAWINGS

Features and advantages of the described implementations can be more readily understood by reference to the following description taken in conjunction with examples of the accompanying drawings.

FIG. 1 is a diagram of an example of a system that includes a touchpad;

FIG. 2 is a diagram of an example of a system that includes a touchpad;

FIG. 3 is a series of diagrams of examples of a system, circuitry, a method and circuitry for touchpad operational mode selection;

FIG. 3 is a diagram of examples of circuitry for various operational modes and some examples of character sets;

FIG. 4 is a series of diagrams of an example of a method;

FIG. 5 is a series of diagrams of an example of a method;

FIG. 6 is a block diagram of an example of a method;

FIG. 7 is a series of diagrams of examples of keyboards;

FIG. 8 is a diagram of an example of an apparatus that includes a touchpad; and

FIG. 9 is a diagram of an example of a system.

### DETAILED DESCRIPTION

The following description includes the best mode presently contemplated for practicing the described implementations. This description is not to be taken in a limiting sense, but rather is made merely for the purpose of describing the general principles of the implementations. The scope of the invention should be ascertained with reference to the issued claims.

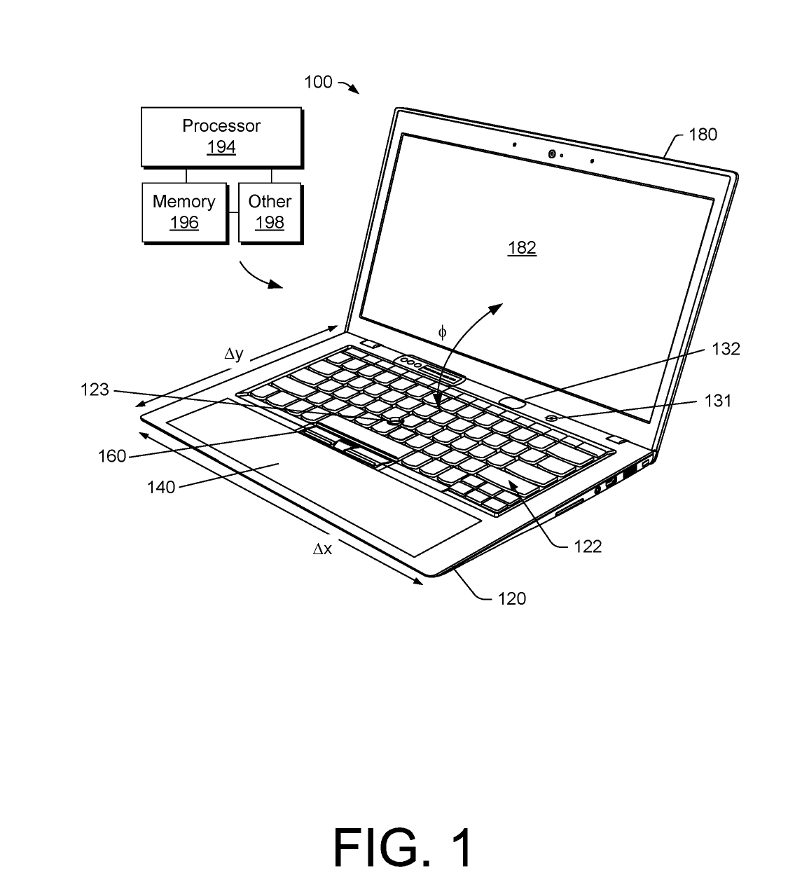

FIG. 1 shows an example of an information handling system 100 that includes a keyboard housing 120 with a keyboard 122 and a display housing 180 with a display 182 that are pivotably coupled, for example, to adjust an angle (ϕ) between the keyboard housing 120 and the display housing 180 about a pivot axis. As an example, the information handling system 100 can include one or more hinges where, for example, in a single hinge configuration, the single hinge may be centered and allow for rotation of the display housing 180 by approximately 180 degrees or more. As an example, the information handling system 100 may include one or more hinges that allow for a tablet orientation where the display housing 180 is oriented with the display 182 facing outwardly. In such an example, the information handling system 100 can be clamshell computer with a closed orientation having the display 182 facing the keyboard 122 (e.g., an angle of about 0 degrees), with a laptop orientation (e.g., an angle between about 70 degrees and about 120 degrees, as shown in FIG. 1) and with a tablet orientation (e.g., an angle of about 360 degrees). As an example, the information handling system 100 may be oriented in a tent orientation (e.g., an angle between about 190 degrees and about 350 degrees) where the display 182 is facing in one direction and supporting the information handling system 100 on a surface along an edge and where the keyboard 122 is facing in another direction and supporting the information handling system 100 on a surface along an edge.

As shown the keyboard housing 120 includes a power button 131, an optional joystick 123, optional status indicators 132, a touchpad 140, and optional touchpad associated buttons 160. As an example, various features of the information handling system 100 may be referenced with respect to a three dimensional coordinate system such as, for example, a Cartesian coordinate system with x, y and z coordinate axes.

In the example of FIG. 1, the touchpad 140 can be defined with respect to the Cartesian coordinate system and may be referenced with respect to the keyboard 122 and/or keys of the keyboard 122. For example, the touchpad 140 can be described as being a wide touchpad that spans a distance in the x direction of at least 8 key widths where such keys are disposed substantially in a row of keys of the keyboard 122. Such a row may be between a left shift key and a right shift key. Such a row of keys may be greater in length than a space bar key.

As an example, the touchpad 140 can be defined with respect to the display 182. For example, the touchpad 140 can be defined as having an aspect ratio that differs from that of the display 182 in that the depth of the touchpad 140 along the y direction is less than a bottom to top distance of the display 182 while the width of the touchpad 140 along the x direction is approximately the same as that of the display 182 or, for example, approximately 50 percent or more of the width of the display 182 or, for example, approximately 60 percent or more of the width of the display 182.

As an example, the touchpad 140 can be defined with respect to the keyboard housing 120 where, for example, the width of the touchpad 140 is approximately 50 percent or more of the width of the keyboard housing 120 or, for example, approximately 60 percent or more of the width of the keyboard housing 120.

As to the depth of the touchpad 140 along the y direction, it may be a fraction of the depth of the keyboard 122. For example, the depth of the touchpad 140 may be approximately 80 percent or less of the depth of the keyboard 122. As an example, the depth of the touchpad 140 along they direction may be defined as being a fraction of the depth of the keyboard housing 120. For example, the touchpad 140 may be approximately 50 percent or less of the depth of the keyboard housing 120.

As an example, the touchpad 140 may be defined using a combination of the aforementioned metrics that reference one or more features of the information handling system 100.

As an example, the touchpad 140 can include light emitting devices below its outermost surface, which can be a touch sensitive surface (e.g., one or more LEDs, etc.). As an example, the touchpad 140 can include a fingerprint reading window and/or a palm print reading window where reading of one or more fingerprints and/or one or more palm prints may act to identify a user (e.g., for logging into and/or using the information handling system 100).

As an example, the touchpad 140 may be an integrated touchpad with a substantially flush surface with the keyboard housing 120. As an example, the size and/or shape of the touchpad 140 may be programmable. As an example, the touchpad 140 may be programmable to operate as a narrow touchpad without various palm-related features or to operate as a wide touchpad with various palm-related features. As an example, an operational mode may be associated with a particular application that executes in an operating system environment. In such an example, upon instantiating the application and having it the focus of an operating system environment, the touchpad 140 may be operational in one or more modes. As an example, a mode may be a toolbar mode where positions along a width of the touchpad 140 correspond to a toolbar of an application (e.g., consider MS WORD tools of a toolbar that may be oriented above a text panel of the MS WORD application).

As an example, a keyboard housing can include a surface that is formed of MYLAR material (e.g., polymeric material), glass, crystal silk, etc., where such a material can be part of a touchpad assembly or a protective layer over a touchpad touch sensitive surface. In such an example, a touchpad may be adjustable as to one or more of its dimensions and/or its shape. As an example, an application may allow a user to customize the size and location of a touchpad or touchpads. For example, the touchpad 140 may be programmable to have two touch sensitive areas for input. In such an example, one touch sensitive area can be a left portion and another touch sensitive area can be a right portion (e.g., left half and a right half, optionally with or without a gap therebetween). In such an example, circuitry can be included in an information handling system that handles palm input from a left palm and/or from a right palm.

The touchpad 140, being a wide touchpad, can be more intuitive for a user. For example, when a two-handed user is viewing information rendered to the display 182 while palms are resting at least in part on the touchpad 140, the user may move one or both palms as input to instruct the information handling system 100. As another example, additionally or alternatively, a user may lift a right hand and thereby lift the right palm off of the touchpad 140 and then use one or more fingers of the right hand to interact with the touchpad 140 (e.g., to touch the touchpad) at approximately the same span along the x direction to provide input to instruct the information handling system 100. For example, consider a user lifting the right hand to lift the right palm off of the touchpad 140 where lifting of the right hand moves the right palm in the y direction away from the keyboard 122 such that one or more fingers (e.g., optionally including the right thumb) can touch the touchpad 140 to have input received via the touchpad 140 that instructs the information handling system 100. While the right hand is mentioned, a method can include the left hand, additionally or alternatively.

In the aforementioned examples, a user does not experience uncertainty as to the position of the touchpad 140, as a user may experience where a touchpad is not a wide touchpad (e.g., a touchpad with a width in the x direction that is less than about five individual character keys in a row). As a wide touchpad can be beneath both palms at the same time, a user can be in contact with the wide touchpad and tactilely know, spatially where the wide touchpad is on the keyboard housing 120 of the information handling system 100. In such an example, a user may make shifts to the left hand and/or the right hand that are in the y direction to use the wide touchpad 140 without having to “search” for the wide touchpad 140 in the x direction. In such an approach, a user may more effectively focus on information rendered to the display 182 and interact with the information handling system 100 as the user is not distracted by “feeling out” the extent (e.g., lateral boundaries) of the wide touchpad 140, as may occur with a narrower touchpad (e.g., a touchpad that may be about the width of approximately 5 individual character keys in a row of a keyboard, which may be a QWERTY keyboard).

The information handling system 100 can be more efficient for a user because movements of a right hand or a left hand may be more direct for keyboard to touchpad interactions and vice versa. For example, movement of a hand or hands in the x direction may be reduced when the wide touchpad 140 is compared to a narrower touchpad (e.g., a touchpad that may be about the width of approximately 5 individual character keys in a row of a keyboard, which may be a QWERTY keyboard). The information handling system 100 may also be more ergonomic in that wrist movements that may be detrimental to tendons or other tissue (e.g., as in repetitive motion disorders) may be reduced.

As a person with a left hand and a right hand extending from a left arm and a right arm as extending from a left shoulder and a right shoulder may be more comfortable having spacing between her left hand and her right hand, the information handling system 100 may be more ergonomic when compared to an information handling system that has a smaller central touchpad that requires the person to shorten the distance between left and right hands when moving the right hand toward center or when moving the left hand toward center.

As an example, the touchpad 140 of the information handling system 100 of FIG. 1 can be utilized for multi-touch input. For example, consider multi-hand, multi-touch input where the right hand and left hand are used simultaneous for input. Such multi-hand, multi-touch input is less ergonomic and may be considerably awkward where an information handling system includes a narrower touchpad that requires closing of the distance between left and right hands, which may impact left and right shoulder, a person's neck, etc.

As an example, a wide touchpad can be a touch/gesture pad that spans between approximately 50 percent up to approximately 100 percent of the width of a keyboard housing, which may be a keyboard housing of an information handling system such as a laptop or notebook computer.

As an example, circuitry associated with a wide touchpad can include palm recognition circuitry. In such an example, a user may rest her hands on the touchpad while typing. Such a user may then move one of her hands anywhere in the palm rest area to start using the wide touchpad, optionally without needing to look at the wide touchpad. As an example, circuitry associated with a wide touchpad can be configurable according to one or more options. For example, an option may be selected that keeps the entire touchpad active such that a user could use left and right hands. As another possible option, a selection may limit an area or areas of the touchpad that is or are active for input. As an example, a user may move a hand down directly where the palm of that hand had been resting where an area of the touchpad that was under the palm is active.

As an example, circuitry associated with a wide touchpad can be learning circuitry that automatically adjusts or sets an active area of the wide touchpad. For example, circuitry associated with a wide touchpad may sense one or more palm dimensions and/or one or more palm movements. The circuitry may distinguish certain palm movements as being associated with key touch typing via fingers of the hand and/or touching of one or more keys for entry of a command or commands (e.g., consider function keys, short cut key combinations, etc.). Circuitry may determine what type of palm movement is associated with a user's intention to utilize a touchpad for entry of input to instruct an information handling system. For example, a slide of a palm in the y direction of the keyboard housing 120 of FIG. 1, associated with a lift-off of the palm may cause the circuitry to activate at least an area of the touchpad 140 that had been directly underneath the palm. In contrast, where palm-based input is enabled, a slide of the palm in the y direction may be analyzed to determine if it is part of a palm-based gesture. For example, consider a palm-based cursor control gesture that analyzes a contact area for a palm and determines a centroid where that centroid is associated with a cursor for movement of the cursor in a manner that corresponds to the movement of the centroid as controlled by the contact area for the palm. In such an example, circuitry can calculate a palm centroid based on a sensed palm contact area. As an example, such circuity may be calibrated according to one or more calibration algorithms where information may be rendered to a display that outlines a palm contact area for a palm in contact with a portion of a touchpad and that renders a centroid or other corresponding point that is to be associated with a cursor.

As an example, an information handling system that includes a keyboard and a touchpad can include an application that allows for user programmable width, user programmable dimension ratio or ratios, user programmable designated input and/or non-input areas of the touchpad, which may be a wide touchpad. As an example, an application may be part of an operating system or an application that execute in an operating system environment. As an example, an application can be a palm recognition application, which may deactivate one or more areas of a touchpad while palms are resting in a relatively stationary manner on the touchpad (e.g., stationary as may be associated with touch typing).

As an example, the information handling system 100 can include a processor 194, memory 196 accessible by the processor and other circuitry 198, which may be operatively coupled to the processor 194. As an example, the memory 196 may store instructions executable by the processor 194. For example, operating system instructions may be stored in the memory 196 and executable by the processor 194 to establish an operating system environment that can be implemented to execute applications.

As an example, the information handling system 100 can include an embedded controller, for example, as the other circuitry 198. In such an example, the embedded controller may perform functions associated with components such as one or more fans, one or more batteries, etc. As an example, an embedded controller may be operatively coupled to a processor. In such an example, the embedded controller may be configured to transfer information to the processor as associated with components and the processor may be configured to transfer information to the embedded controller as associated with an operating system environment. For example, an embedded controller of a system may transfer a status of a system component to a processor of the system that may cause the processor to shut down the system and the processor may transfer a command to the embedded controller to cause the embedded controller to control a component. As an example, a component may be operable via firmware where a processor and/or an embedded controller may be operatively coupled to the component to instruct component firmware and/or to receive information from component firmware.

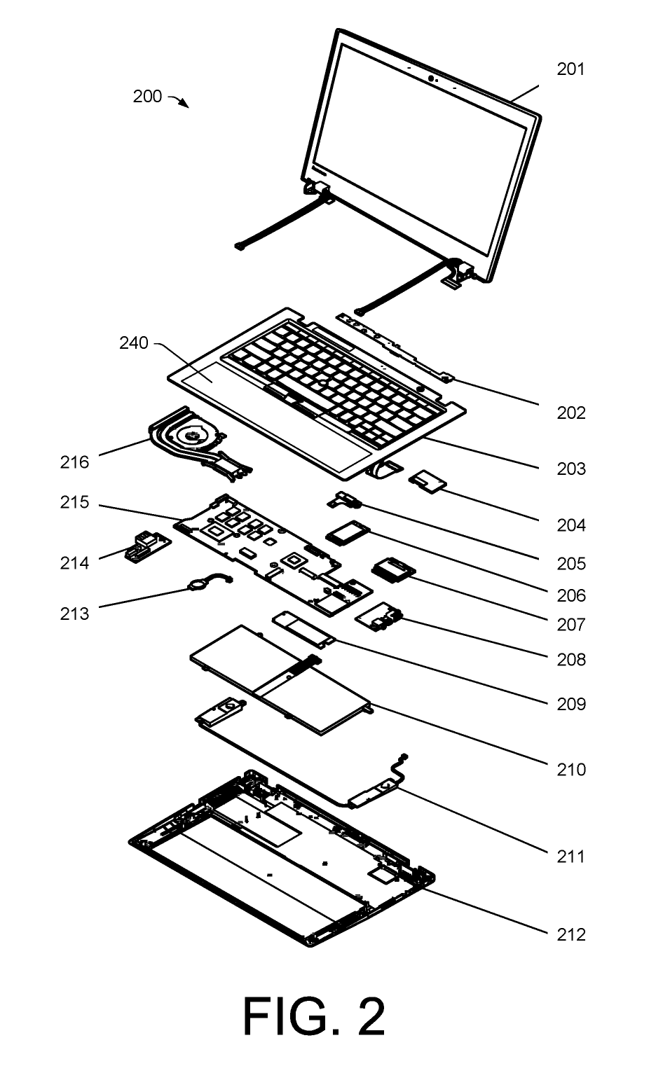

FIG. 2 shows an example of a system 200 that includes an LCD unit 201, a circuitry board 202, a keyboard bezel assembly 203, a fingerprint reader 204, a Bluetooth® technology circuitry 205, a wireless LAN circuitry 206, wireless WAN circuitry 207, audio circuitry 208, a solid-state drive 209, one or more batteries 210, a speaker assembly 211, a base cover assembly 212, a backup battery 213, USB circuitry 214, a circuitry board 215, a fan assembly 216 and a touchpad 240. As an example, the touchpad 240 may be operatively coupled to one or more of the circuitry boards such as, for example, the circuitry board 215, which can include one or more processors.

As an example, the touchpad 240 can include various features of a touchpad such as the Synaptics TouchPad (Synaptics Inc., Santa Clara, Calif.). As an example, a touchpad may be a touch-sensitive interface that senses the position of a user's finger (or fingers) on its surface and that senses the position of a user's palm or palms on its surface. As an example, a touchpad may include circuitry for one or more of capacitive sensing, conductance sensing or other sensing.

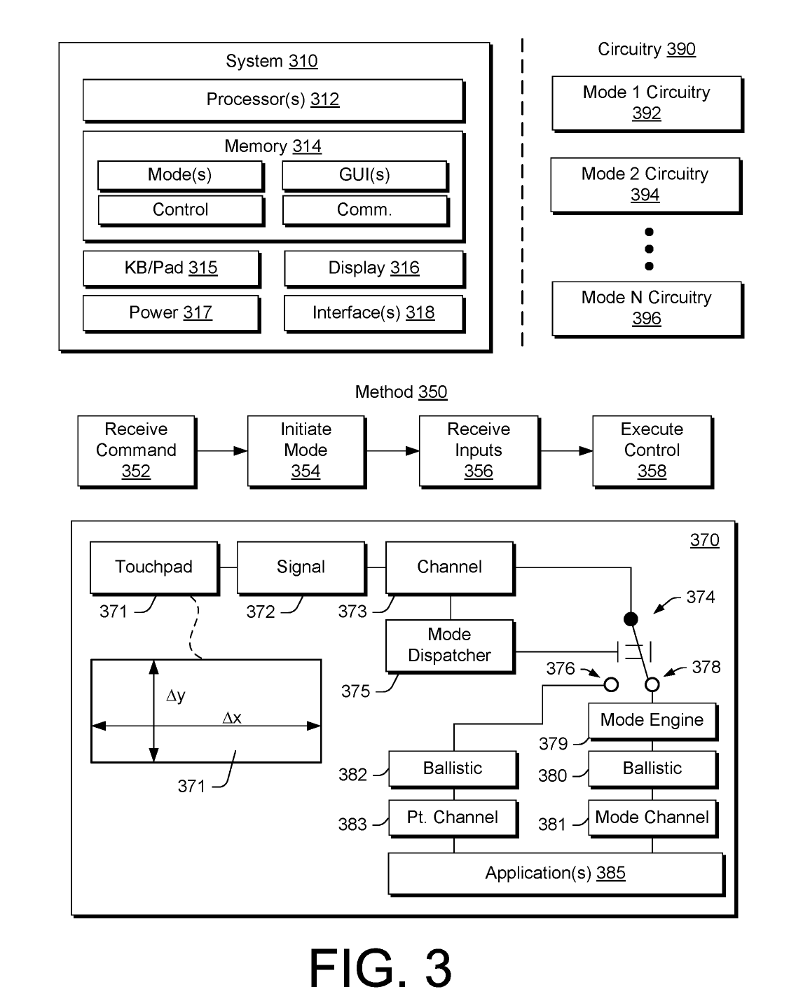

FIG. 3 shows an example of a system 310, an example of a method 350, an example of a sub-system 370 and examples of circuitry 390. As to the system 310, it includes one or more processors 312 (e.g., cores), memory 314 (e.g., one or more memory devices that include memory), a keyboard (KB) with an associated touchpad 315, a display 316, a power supply 317 and one or more communication interfaces 318. As an example, a communication interface may be a wired or a wireless interface. In the example of FIG. 3, the memory 314 can include one or more modules such as, for example, a mode module, a control module, a GUI module and a communication module. Such modules may be provided in the form of instructions, for example, directly or indirectly executable by at least one of the one or more processors 312.

In the example of FIG. 3, the method 350 includes a reception block 352 for receiving a command, an initiation block 354 for initiating a touchpad operational mode responsive to the command, a reception block 356 for receiving one or more inputs and an execution block 358 for executing one or more actions based at least in part on at least one of the one or more received inputs, for example, where the one or more actions comport with specifications of the touchpad operational mode.

As to the sub-system 370 of FIG. 3, it includes a touchpad 371 for output of a signal 372 via a channel 373. As shown in the example of FIG. 3, the channel 373 outputs a signal to a switch 374 and also to a mode dispatcher 375. Depending on the type of signal, as interpreted by the mode dispatcher 375, the switch switches operational mode of the touchpad. For example, to the left is a “normal” state 376 while to the right is a “mode” state 378 for a particular mode. As an example, where the mode dispatcher 375 causes the switch 374 to select the mode state 378, a mode engine 379 receives the signal via the channel and processes it via appropriate ballistics 380 and an associated mode channel 381 (or mode channels), for example, to provide for interaction with one or more applications 385 (e.g., code executing at least in part on a system). As indicated in the example of FIG. 3, where the switch 374 is to the left, in the normal state 376, the signal via the channel is processed using appropriate ballistics 382 and an associated pointing channel 383, for example, to provide for interaction with one or more applications 385 (e.g., code executing at least in part on a system such as to associate the signal with a cursor graphic rendered by a system to a display).

As to a particular type of touchpad device, a communication specification entitled “MEP Over I²C: Synaptics I²C Physical Layer Specification” (PN: 511-000039-01 Rev. B, 2007), which is incorporated by reference herein, describes communication technologies and techniques.

FIG. 3 also shows an example of the touchpad 371 (e.g., touch input surface) with dimensions in an x, y coordinate system. Such dimensions can be associated with a keyboard housing such as the keyboard housing 120 of the information handling system 100 of FIG. 1 or the system 200 of FIG. 2.

As to the circuitry 390, in the example of FIG. 3, circuitry components 392, 394 and 396 are shown as being associated with modes 1, 2 and N. As an example, the circuitry components 392, 394 and 396 may include instructions executable by a processor to instruction a system to perform one or more actions. For example, the circuitry components 392, 394 and 396 may be or may include instructions stored or storable in one or more computer-readable (e.g., processor-readable) storage media (e.g., one or more memory devices). As an example, the memory 314 of the system 310 may include such instructions for implementation of the mode 1 circuitry 392, the mode 2 circuitry 394 or the mode N circuitry 396. As indicated, circuitry for more than one mode may be provided.

As an example, the sub-system 370 may be operable according to one or more of the modes 1, 2 and N (e.g., where N is some arbitrary number associated with a total number of modes). As an example, mode 1 circuitry 392 may, at least in part, control operation of the mode dispatcher 375 and the mode engine 379 of the sub-system 370. As an example, where multiple modes are available in addition to a “normal” mode (e.g., “normal” state 376 of the switch of the sub-system 370), a mode dispatcher (e.g., such as the mode dispatcher 375) may be configured to associated signals with modes for purposes of selecting an appropriate mode engine (e.g., such as the mode engine 379). For example, the mode dispatcher 375 of the sub-system 370 may include an association table for gesture signals and each of the modes 1, 2 and N (e.g., as well as any intermediate mode between mode 2 and mode N).

While the sub-system 370 of FIG. 3 shows the mode dispatcher 375 as being dependent on the signal 372 from the touchpad 371, one or more other approaches may be implemented to select or switch a mode.

As an example, a mode may be a palm rejection mode, a palm tracking mode, a finger tracking mode, a multi-touch mode, a gesture mode, a training mode, a user setup mode, etc. As an example, a mode may be associated with a particular application. For example, consider a word processing application, which may include a particular set of functions associated with input via a touchpad.

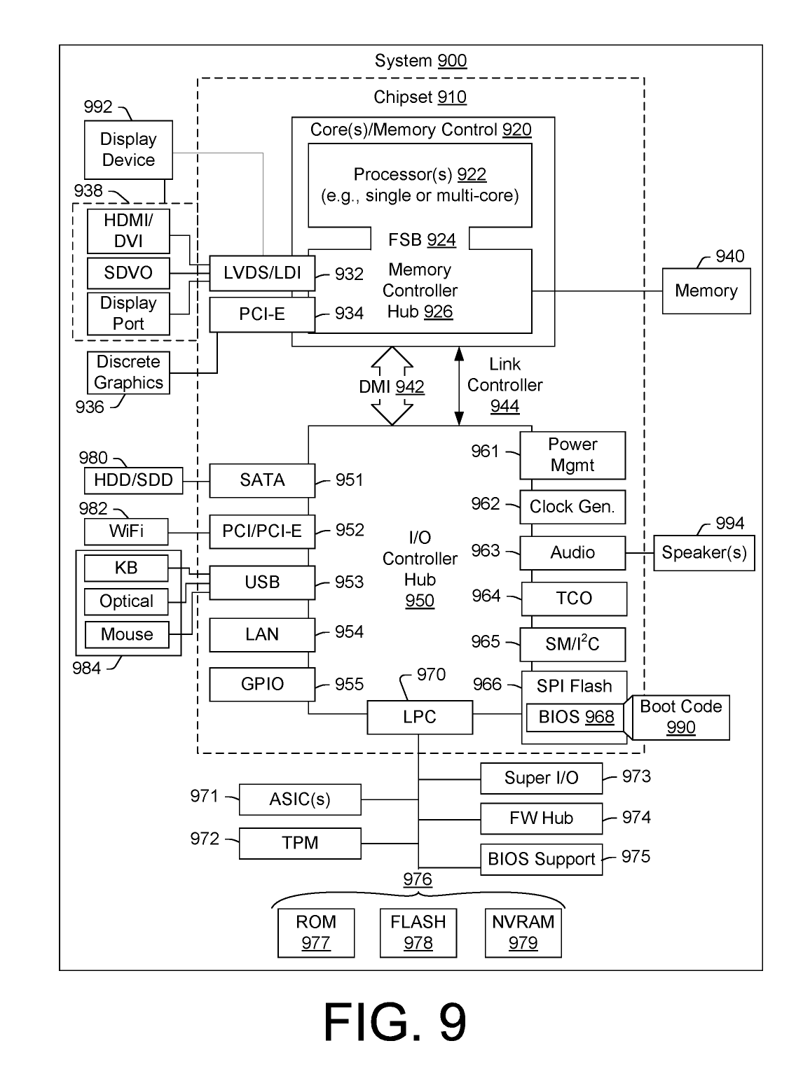

As an example, a system can include an interface to pass data from a touchpad to an operating system (OS), applications, etc. For example, such an interface may be an HID-I2C or an HID-USB (see also, e.g., FIG. 9). As an example, interface support circuitry may utilize a SMBus (e.g., running via a physical I2C interface or “I²C”). As an example, interface support circuitry may provide for multi-touch “full-time finger tracking” (e.g., for gestures), for palm rejection, for palm recognition, for palm tracking, for palm-based gestures, etc.

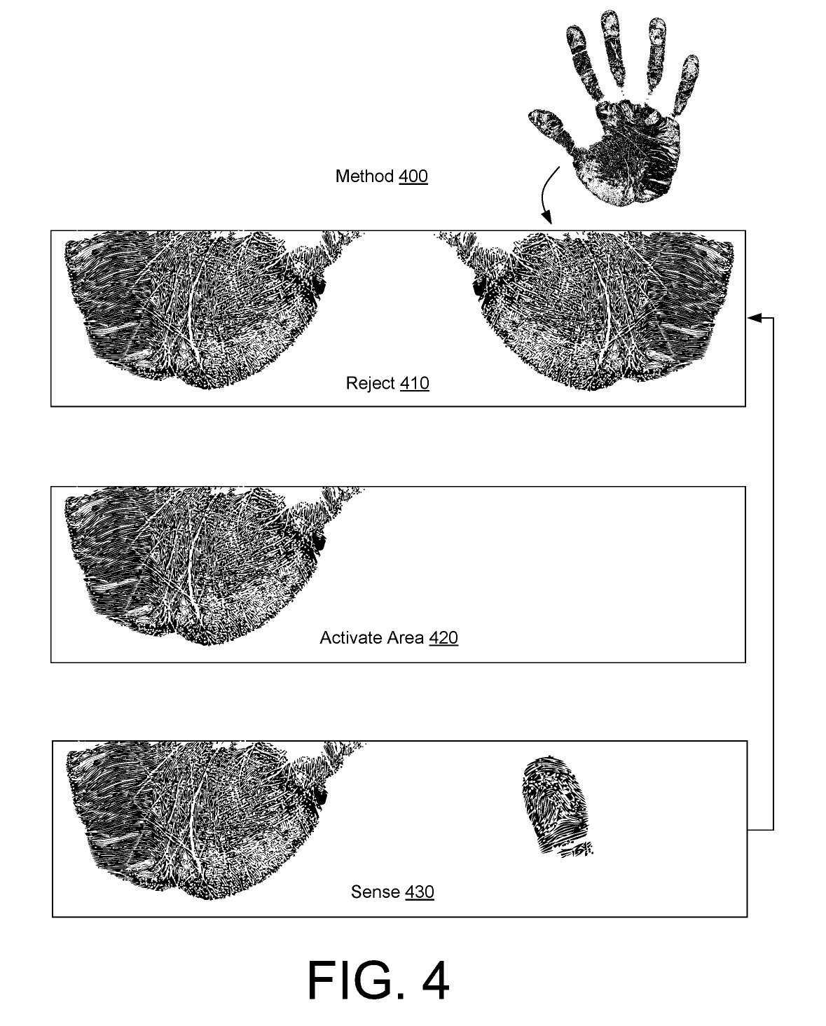

FIG. 4 shows an example of a method 400 that includes a rejection block 410 for rejecting palm input of palms in direct contact with a touchpad, an activation block 420 for activing an area of the touchpad responsive to detection of an absence of palm input for at least a portion of the touchpad, and a sensation block 430 for sensing input in the activated area of the touchpad. In such an example, the activated area can correspond to an area of the touchpad where a change in state has occurred from a palm contact state to a no palm contact state, which may be a palm rejection state to a non-palm rejection state.

As shown in the example of FIG. 4, the method 400 can include returning to the rejection block 410 where the right palm is again detected as being in direct contact with the touchpad, which may be relatively static contact for a period of time. For example, consider direct contact with relatively little movement of the right palm for a period of time greater than approximately one second. In such an example, a user may position the right palm and then commence touch typing by contacting one or more keys via fingers of the right hand. A delay between placement of the right palm in direct contact with the touchpad and commencement of touch typing using one or more fingers of the right hand may be of the order of about one second, which is an amount of time sufficient to reject sensed input associated with the direct contact of the right palm with the touchpad. While the aforementioned example refers to the right palm, it may apply equally to the left palm. And, as an example, where both palms are lifted (e.g., not in direct contact with the touchpad), a method may enter a fully active mode of the surface of the touchpad. For example, consider a music keyboard (e.g., piano) application, a drawing application, etc. where the touchpad may be utilized as an input device for input to the application. In the music keyboard application example, the touchpad may correspond to a number of piano keys (e.g., an octave to about two octaves), which may be utilized for playing music, entering musical notes in a score, etc. As an example, a swipe gesture (e.g., widthwise) may act to move the keys to higher or lower frequency keys (e.g., other octaves, etc.). As to the drawing application example, the touchpad may correspond to a touchpad that can provide an approximately one-to-one correspondence between the width of the touchpad and the width of graphics rendered to a display (e.g., or image, etc.). As an example, a swipe gesture (e.g., depthwise) may act to move the touchpad to an upper or a lower portion of a display.

As an example, a method can include independently detecting contact of a palm in a left portion of a touchpad and detecting contact of a palm in a right portion of a touchpad. In such an example, detection of non-contact of a palm in the left portion can activate the left portion of the touchpad for instructional touch input (e.g., one or more commands) and detection of non-contact of a palm in the right portion can activate the right portion of the touchpad for instructional touch input (e.g., one or more commands).

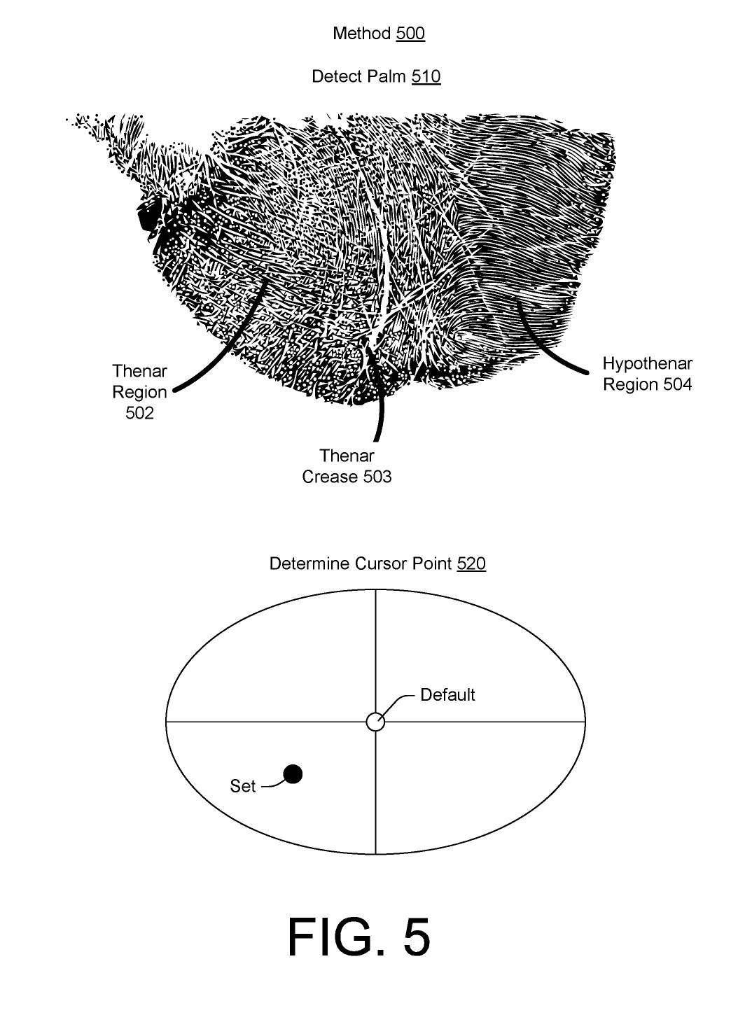

FIG. 5 shows an example of a method 500 that includes a detection block 510 for detecting a palm that is in direct contact with a touchpad and a determination block 520 for determining a cursor point associated with the direct contact of the palm with the touchpad. FIG. 5 also shows a palm print as including a thenar region 502, a thenar crease 503 and a hypothenar region 504.

In the example of FIG. 5, a default cursor point is shown as being a central point (e.g., a centroid) of a shape that approximates the contact of the palm and another point is shown as being a set cursor point, which may be set, for example, using an application setting, a user parameter setting, etc. For example, a user may set a cursor point to correspond to a fleshy portion of the palm such as the thenar region 502 of the palm. The thenar region 502 corresponds to the thenar eminence, which refers to the group of muscles on the palm of the human hand at the base of the thumb. The thenar region 502 may be defined in part by a proximal point (e.g., at the edge of the wrist) to a distal point (e.g., at the base of the thumb). As an example, the thenar region 502 of the palm (e.g., thenar portion) may be defined at least in part by the thenar crease 503 where the thenar region 502 is to the thumb side of the thenar crease 503 and where another region, the hypothenar region 504 (e.g., as associated with the hypothenar eminence), is to the small finger side of the thenar crease 503. As an example, a touchpad may be of a width that accommodates the thenar regions of left and right palms simultaneously or, for example, the thenar and the hypothenar regions of left and right palms simultaneously. In the example of FIG. 5, the palm print includes the thenar crease 503 (see prominent white curving line) with the thumb to the left of the thenar crease 503 and with the hypothenar region 504 to the right of the thenar crease 503. The thenar crease 503 has been referred to at times as the “lifeline” in palmistry.

As an example, a user may set a cursor point to correspond to a portion of a palm. For example, consider tilting the palm such that a portion of the palm is not in direct contact with a touchpad while another portion of the palm is in direct contact with the touchpad (e.g., consider part of the thenar portion). In such an example, a centroid calculation may be utilized to determine a cursor point, which may be according to a setting or settings (e.g., one or more parameters). In the example of FIG. 5, consider tilting of the palm such that only a portion of the palm that corresponds roughly to the left side of the oval or the roughly to the lower left quadrant of the oval.

The example method 500 of FIG. 5 demonstrates how a palm or a portion of a palm (e.g., a region) may be utilized to contact a touchpad to control a cursor position of a cursor rendered to a display of a device to which the touchpad is operatively coupled (e.g., via wire or wirelessly).

As to dimensions of a hand, or a portion thereof, consider a human hand with a palm width Δxₚ where an adult male human hand on average may have a palm width of about 84 mm (about 3.3 inches) and an adult female human hand on average may have a palm width of about 74 mm (about 2.9 inches) and where a touchpad can be wide enough to simultaneously be in direct contact with a left palm and a right palm (e.g., where there may possibly be an amount of space between the palms). For example, consider a touchpad that is at least approximately 150 mm wide (e.g., about 6 inches wide) (e.g., x direction). As an example, such a touchpad can be at least approximately 40 mm in depth (e.g., about 1.5 inches) (e.g., y direction). As to an aspect ratio, a touchpad may be of a width that is at least about double a depth (e.g., consider a touchpad that is about 150 mm wide and 75 mm in depth).

With reference to FIG. 5, a wide touchpad that accommodates a left palm thenar region and a right palm thenar region simultaneously may be dimensioned using the foregoing dimensions, optionally scaled with respect to the palm print of FIG. 5, which shows the thenar crease 503 as a landmark (e.g., fiduciary). For example, a thenar region may be about 50 percent of a palm width. As an example, a thenar region touchpad may include a left thenar region area of about 45 mm (about 1.8 inches) and a right thenar region area of about 45 mm (about 1.8 inches) and an inter-thenar area of about 35 mm (e.g., about 1.4 inches) such that a contiguous touchpad may be of a width of approximately 120 mm (e.g., about 5 inches). As an example, a touchpad region with a left area touchpad and a right area touchpad and an inter-area therebetween may be operative coupled to palm rejection circuitry and may be operatively coupled to touch input circuitry (e.g., for finger and/or palm-based touch input).

As mentioned, dimensions of a touchpad may be defined with respect to keys of a keyboard and/or one or more other dimensions. As an example, a touchpad may be of a width that is less than the width of two palms that are side-by-side (e.g., in an x direction). For example, a touchpad may be wide enough to be in direct contact with a portion of a left palm and simultaneously be in direct contact with a portion of a right palm where those portions correspond to the index and middle fingers of each hand as the touchpad may be used by directly touching the index finger tip (e.g., finger pad) and/or the middle finger tip (e.g., finger pad) to the touchpad when a corresponding palm or palms are moved away from keys of a keyboard in a direction toward a front edge of a keyboard housing (see, e.g., FIG. 4).

As an example, a keyboard housing can include a wide touchpad that may be a thenar touchpad that has a width (x direction) that accommodates a left palm thenar region and a right palm thenar region such that both thenar regions can be in direct contact with the touchpad simultaneously while, for example, fingers of the left and right hands may be utilized for touch typing on a keyboard of the keyboard housing. In such an example, the width of the touchpad can be, for example, at least an S-to-L key distance of the S key and the L key of the keyboard of the keyboard housing.

As an example, a method can include a rejection block for rejecting a static right palm signal and a static left palm signal generated via a touchpad of a keyboard housing disposed between a spacebar of a keyboard of the keyboard housing and a front end of the keyboard housing where the touchpad extends a lateral distance greater than an S-to-L key distance of the keyboard; a detection block for detecting a dynamic touch signal generated via the touchpad; and an issuance block for, responsive to the dynamic touch signal, issuing a command.

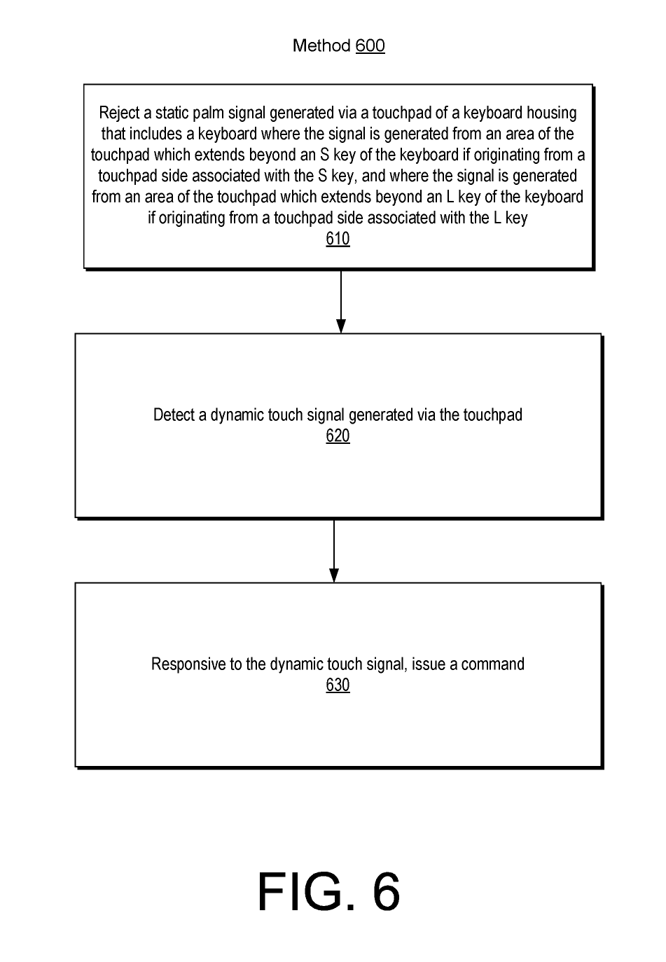

FIG. 6 shows an example of a method 600 that includes a rejection block 610 for rejecting a static palm signal generated via a touchpad of a keyboard housing that includes a keyboard where the signal is generated from an area of the touchpad which extends beyond an S key of the keyboard if originating from a touchpad side associated with the S key, and where the signal is generated from an area of the touchpad which extends beyond an L key of the keyboard if originating from a touchpad side associated with the L key; a detection block 620 for detecting a dynamic touch signal generated via the touchpad; and an issuance block 630 for, responsive to the dynamic touch signal, issuing a command.

As an example, a method can include receiving a dynamic touch signal that corresponds to a dynamic finger touch signal associated with a finger sized area (see, e.g., the fingerprint of FIG. 4). As an example, a dynamic touch signal can correspond to a dynamic palm touch signal associated with a palm sized area (see, e.g., the palm prints of FIG. 4). As an example, a dynamic touch signal can correspond to a dynamic palm gesture signal and a corresponding command can be, for example, a scroll command. As an example, a dynamic touch signal can correspond to a first dynamic palm gesture signal associated with a left half of a touchpad and a second dynamic palm gesture signal associated with a right half of the touchpad. As an example, a dynamic touch signal can correspond to a thumb touch signal associated with a central portion of a touchpad. In such an example, the dynamic touch signal may correspond to a multiple thumb touch signal associated with a central portion of the touchpad.

As an example, one or more computer-readable media can include computer-executable instructions to instruct a computer to: reject a static right palm signal and a static left palm signal generated via a touchpad of a keyboard housing disposed between a spacebar of a keyboard of the keyboard housing and a front end of the keyboard housing where the touchpad extends a lateral distance greater than an S-to-L key distance of the keyboard; detect a dynamic touch signal generated via the touchpad; and responsive to the dynamic touch signal, issue a command. In such an example, the computer-executable instructions can include instructions to instruct the computer to reject a static left palm signal generated via a left half of the touchpad and to detect the dynamic touch signal generated via a right half of the touchpad and/or instructions to instruct a computer to reject a static right palm signal generated via a right half of the touchpad and to detect the dynamic touch signal.

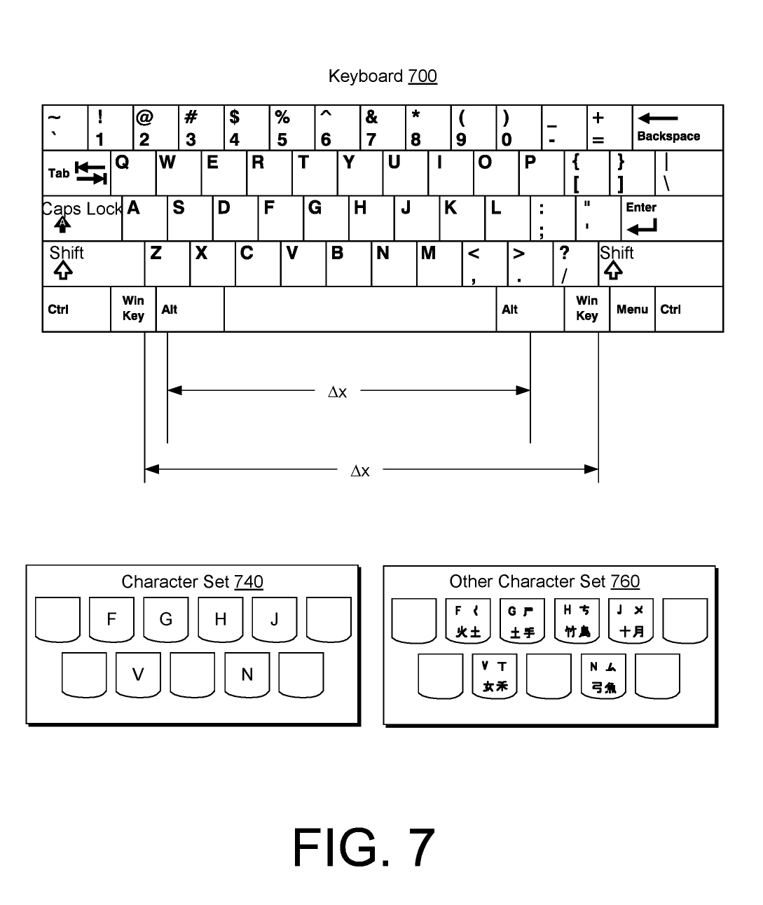

FIG. 7 shows an example of a keyboard 700 that is an example of a QWERTY keyboard where distances are indicated as being between outer widthwise edges of the S key (left side) and the L key (right side) and as being between inner widthwise edges of the left side shift key and the right side shift key. FIG. 7 also shows a character set 740 that corresponds to the keyboard 700 and another example of a character set 760, which includes East Asian characters.

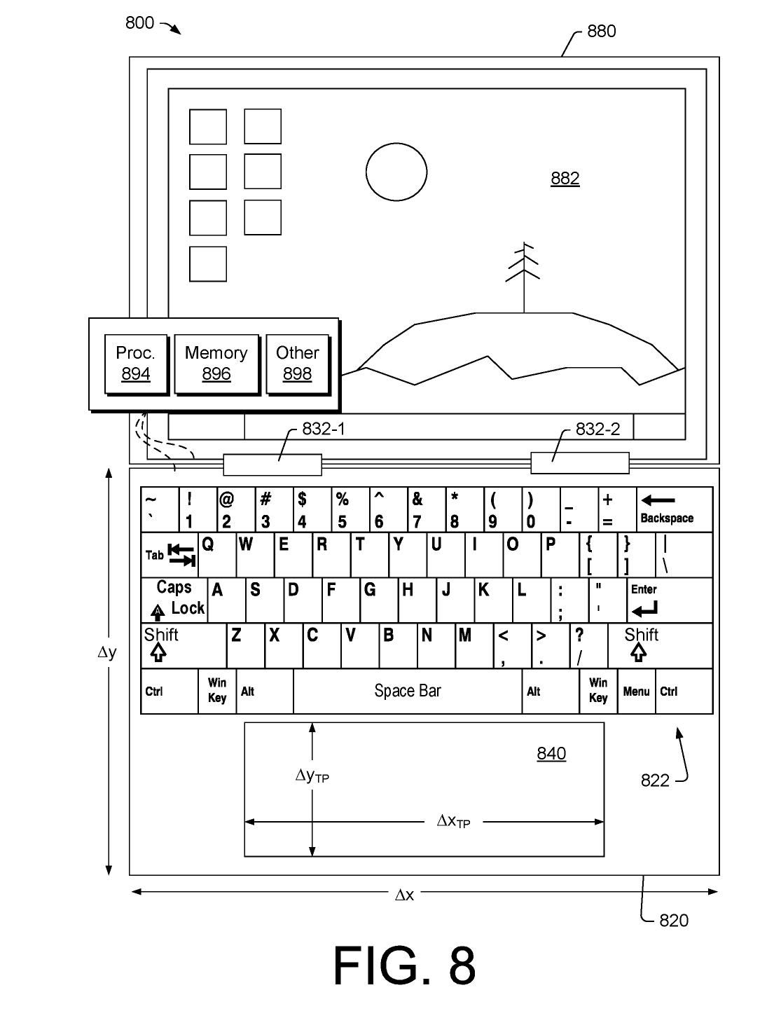

FIG. 8 shows an example of an apparatus 800 that includes a processor 894; memory 896 accessible by the processor 894; and a display housing 880, a keyboard housing 820 and a hinge assembly 832-1 and 832-2 that rotatably couples the display housing 880 and the keyboard housing 820 where the keyboard housing 820 includes a hinge assembly end, a front end, a left side and a right side; a keyboard 822 that includes a spacebar, an S key, an L key and an S-to-L key distance; and a touchpad 840 disposed between the spacebar and the front end that extends a left side to right side distance (e.g., Δx_{TP}) greater than the S-to-L key distance. In the example of FIG. 8, the touchpad 840 includes a front end side to spacebar side distance labeled Δy_{TP}. As an example, the hinge assembly can include one or more hinges. As an example, a touchpad can be greater than an S-to-L key distance and shifted such that it may not be centered with a center of that distance or, for example, a center of a touchpad in the x direction may correspond to a center of an S-to-L key distance (e.g., or other defined keyboard related distance).

As an example, the apparatus 800 can include palm rejection circuitry (e.g., see other block 898) operatively coupled to the touchpad 840. As an example, the apparatus 800 can include gesture recognition circuitry (see, e.g., the other block 898) operatively coupled to the touchpad 840. In such an example, the gesture recognition circuitry can include multi-touch gesture recognition circuitry.

As an example, the touchpad 840 can include a left palm rest portion and a right palm rest portion (see, e.g., FIG. 4). As an example, gesture recognition circuitry can include palm-based gesture recognition circuitry. For example, consider palm-based gesture recognition circuitry that includes a library that includes a palm-based horizontal slide gesture and a palm-based vertical slide gesture. For example, with reference to FIG. 4, consider sliding the right palm and/or the left palm in direct contact with a touchpad where such sliding is horizontal (e.g., x direction) or vertical (e.g., y direction) or optionally a combination of both horizontal and vertical. Such an approach can provide for single palm and/or dual palm gestures. As an example, palm-based gesture recognition circuitry can include a library that includes at least one dual palm-based gesture. For example, consider sliding right and left palms toward each other to compress an image rendered to a display (e.g., to shrink the image in at least its horizontal direction, which may be the x direction). As another example, consider sliding right and left palms away from each other to expand an image rendered to a display (e.g., to stretch the image in at least its horizontal direction, which may be the x direction). As an example, consider a shearing gesture where one palm is slid upwardly in the y direction (e.g., toward a hinge assembly end of a keyboard housing) and another palm is slid downwardly in the y direction (e.g., toward a front edge of a keyboard housing).

As an example, a spacebar (e.g., or space bar) can be defined in part by a spacebar width where a touchpad has a left to right distance greater than the spacebar width. As an example, a keyboard can include a left side shift key, a right side shift key and a left side shift key to a right side shift key distance where a touchpad extends a left side to right side distance greater than the left side shift key to a right side shift key distance.

As an example, a keyboard housing can include a spacebar and one or more buttons such as one or more of the buttons 160 of the information handling system 100, which are shown as being between the wide touch pad 140 and a spacebar of the keyboard 122. As an example, a wide touchpad can be between one or more buttons and a front edge of a keyboard housing. In such an example, the one or more buttons may be accessible via a right thumb and/or a left thumb while a right palm is in direct contact with the wide touchpad and/or while a left palm is in direct contact with the wide touchpad. For example, a user may rest both palms on the wide touchpad and utilize one or more of the buttons via a thumb or thumbs. As an example, a user may move a palm or palms as a gesture or gestures while optionally actuating one or more buttons with a thumb or thumbs. As an example, a gesture may be a combined action of a palm and a thumb where the palm moves on a touchpad and where the thumb actuates a button.

As an example, a keyboard housing with a keyboard and a wide touchpad may be a unit that includes a wired and/or a wireless interface for operatively coupling circuitry of the keyboard housing (e.g., keyboard circuitry and touchpad circuitry) with another device (e.g., a computer, a television, etc.), which has a corresponding wired and/or wireless interface. Such a keyboard housing may be associated with one or more applications that can execute in an operating system environment for input that may control a cursor rendered to a display, selection of one or more graphics rendered to a display, etc. As an example, a keyboard housing may include a power supply such as, for example, one or more batteries and/or, for example, may receive power via an interface (e.g., USB interface, etc.).

As an example, an apparatus can include a processor; memory accessible by the processor; and a display housing, a keyboard housing and a hinge assembly that rotatably couples the display housing and the keyboard housing where the keyboard housing includes a hinge assembly end, a front end, a left side and a right side; a keyboard that comprises a spacebar, an S key, an L key and an S-to-L key distance; and a touchpad disposed between the spacebar and the front end that extends a left side to right side distance greater than the S-to-L key distance. In such an example, the processor may be disposed in the display housing or in the keyboard housing and the touchpad can be operatively coupled to the processor, for example, to allow for input that may instruct the processor to move a cursor rendered to a display of the display housing. As an example, a touchpad may be a wide touchpad. As an example, a touchpad may be a thenar touchpad that can accommodate at least a thenar region of a right palm and a thenar region of a left palm simultaneously.

As an example, an apparatus can include palm rejection circuitry operatively coupled to a touchpad. As an example, an apparatus can include gesture recognition circuitry operatively coupled to a touchpad. In such an example, the gesture recognition circuitry can include multi-touch gesture recognition circuitry.

As an example, a touchpad can include a left palm rest portion and a right palm rest portion. In such an example, gesture recognition circuitry operatively coupled to the touchpad can include palm-based gesture recognition circuitry. As an example, palm-based gesture recognition circuitry can include or be operatively coupled to a library that can include a palm-based horizontal slide gesture and a palm-based vertical slide gesture. In such an example, a palm may be moved in a rest portion of a touchpad to enter a gesture. For example, upon actuation of a mechanism, palm rejection may be disabled or otherwise switched to allow for detection of palm movement as a type of tactile input. As an example, a library may include at least one dual palm-based gesture.

As an example, a spacebar of a keyboard can have a spacebar width where a touchpad has a left to right distance greater than the spacebar width.

As an example, a keyboard can include a left side shift key, a right side shift key and a left side shift key to a right side shift key distance where a touchpad extends a left side to right side distance greater than the left side shift key to a right side shift key distance.

As an example, a method can include rejecting a static palm signal generated via a touchpad of a keyboard housing that includes a keyboard where the signal is generated from an area of the touchpad which extends beyond an S key of the keyboard if originating from a touchpad side associated with the S key, and where the signal is generated from an area of the touchpad which extends beyond an L key of the keyboard if originating from a touchpad side associated with the L key; detecting a dynamic touch signal generated via the touchpad; and, responsive to the dynamic touch signal, issuing a command. In such an example, the areas can be part of a contiguous area that has a width that is greater than an S key to L key distance. In such an example, a portion of the static palm signal may be within a span of the S key to L key as measured below a spacebar of the keyboard. As an example, a touchpad can be defined as having two halves where a left half is associated with an S key and wherein a right half is associated with an L key. In such an example, the halves may be equal in width and may be part of a contiguous touchpad or, for example, may be halves of a touchpad region where an inactive gap may exist between the two halves.

As an example, a method can include rejecting a static palm signal generated via a touchpad of a keyboard housing that includes a keyboard where the signal is generated from an area of the touchpad which extends beyond an S key of the keyboard if originating from a touchpad side associated with the S key, and where the signal is generated from an area of the touchpad which extends beyond an L key of the keyboard if originating from a touchpad side associated with the L key; detecting a dynamic touch signal generated via the touchpad; and, responsive to the dynamic touch signal, issuing a command. In such an example, the dynamic touch signal can correspond to a dynamic finger touch signal associated with a finger sized area or, for example, the dynamic touch signal can correspond to a dynamic palm touch signal associated with a palm sized area.

As an example, a dynamic touch signal can correspond to a dynamic palm gesture signal where an issued command corresponding to the dynamic touch signal can be a scroll command.

As an example, a dynamic touch signal can correspond to a first dynamic palm gesture signal generated from the area of the touchpad side associated with the S key and a second dynamic palm gesture signal generated from the area of the touchpad side associated with the L key.

As an example, a dynamic touch signal can correspond to a thumb touch signal associated with a central portion of a touchpad, which can be a wide touchpad. In such an example, the dynamic touch signal may correspond to a multiple thumb touch signal associated with the central portion of the touchpad.

As an example, one or more computer-readable media can include computer-executable instructions to instruct a computer to: reject a static palm signal generated via a touchpad of a keyboard housing that includes a keyboard where the signal is generated from an area of the touchpad which extends beyond an S key of the keyboard if originating from a touchpad side associated with the S key, and where the signal is generated from an area of the touchpad which extends beyond an L key of the keyboard if originating from a touchpad side associated with the L key; detect a dynamic touch signal generated via the touchpad; and responsive to the dynamic touch signal, issue a command. In such an example, the instructions can include instructions to instruct the computer to reject a static palm signal generated via the area of the touchpad side associated with the S key and to detect a dynamic touch signal generated via the area of the touchpad side associated with the L key and the instructions can include instructions to instruct the computer to reject a static palm signal generated via the area of the touchpad side associated with the L key and to detect a dynamic touch signal generated via the area of the touchpad side associated with the S key.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions. Such circuitry may optionally rely on one or more computer-readable media that includes computer-executable instructions. As described herein, a computer-readable medium may be a storage device (e.g., a memory card, a storage disk, etc.) and referred to as a computer-readable storage medium. A computer-readable storage medium is non-transitory, not a carrier wave and not a signal.

While various examples of circuits or circuitry have been discussed, FIG. 9 depicts a block diagram of an illustrative computer system 900. The system 900 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a satellite, a base, a server or other machine may include other features or only some of the features of the system 900. As an example, the system 100 may be a device, the system 200 may be a device, and the apparatus 800 may be a device that includes at least some of the features of the system 900, which may be a system of a device.

As shown in FIG. 9, the system 900 includes a so-called chipset 910. A chipset refers to a group of integrated circuits, or chips, that are designed to work together. Chipsets are usually marketed as a single product (e.g., consider chipsets marketed under the brands INTEL®, AMD®, etc.).

In the example of FIG. 9, the chipset 910 has a particular architecture, which may vary to some extent depending on brand or manufacturer. The architecture of the chipset 910 includes a core and memory control group 920 and an I/O controller hub 950 that exchange information (e.g., data, signals, commands, etc.) via, for example, a direct management interface or direct media interface (DMI) 942 or a link controller 944. In the example of FIG. 9, the DMI 942 is a chip-to-chip interface (sometimes referred to as being a link between a “northbridge” and a “southbridge”).

The core and memory control group 920 include one or more processors 922 (e.g., single core or multi-core) and a memory controller hub 926 that exchange information via a front side bus (FSB) 924. As described herein, various components of the core and memory control group 920 may be integrated onto a single processor die, for example, to make a chip that supplants the conventional “northbridge” style architecture.

The memory controller hub 926 interfaces with memory 940. For example, the memory controller hub 926 may provide support for DDR SDRAM memory (e.g., DDR, DDR2, DDR3, etc.). In general, the memory 940 is a type of random-access memory (RAM). It is often referred to as “system memory”.

The memory controller hub 926 further includes a low-voltage differential signaling interface (LVDS) 932. The LVDS 932 may be a so-called LVDS Display Interface (LDI) for support of a display device 992 (e.g., a CRT, a flat panel, a projector, etc.). A block 938 includes some examples of technologies that may be supported via the LVDS interface 932 (e.g., serial digital video, HDMI/DVI, display port). The memory controller hub 926 also includes one or more PCI-express interfaces (PCI-E) 934, for example, for support of discrete graphics 936. Discrete graphics using a PCI-E interface has become an alternative approach to an accelerated graphics port (AGP). For example, the memory controller hub 926 may include a 16-lane (x16) PCI-E port for an external PCI-E-based graphics card. A system may include AGP or PCI-E for support of graphics.

The I/O hub controller 950 includes a variety of interfaces. The example of FIG. 9 includes a SATA interface 951, one or more PCI-E interfaces 952 (optionally one or more legacy PCI interfaces), one or more USB interfaces 953, a LAN interface 954 (more generally a network interface), a general purpose I/O interface (GPIO) 955, a low-pin count (LPC) interface 970, a power management interface 961, a clock generator interface 962, an audio interface 963 (e.g., for speakers 994), a total cost of operation (TCO) interface 964, a system management bus interface (e.g., a multi-master serial computer bus interface) 965, and a serial peripheral flash memory/controller interface (SPI Flash) 966, which, in the example of FIG. 9, includes BIOS 968 and boot code 990. With respect to network connections, the I/O hub controller 950 may include integrated gigabit Ethernet controller lines multiplexed with a PCI-E interface port. Other network features may operate independent of a PCI-E interface.

The interfaces of the I/O hub controller 950 provide for communication with various devices, networks, etc. For example, the SATA interface 951 provides for reading, writing or reading and writing information on one or more drives 980 such as HDDs, SDDs or a combination thereof. The I/O hub controller 950 may also include an advanced host controller interface (AHCI) to support one or more drives 980. The PCI-E interface 952 allows for wireless connections 982 to devices, networks, etc. The USB interface 953 provides for input devices 984 such as keyboards (KB), a touchpad or touchpads, one or more optical sensors, mice and various other devices (e.g., cameras, phones, storage, media players, etc.). As noted, a touchpad may be implemented using one or more types of interfaces (e.g., the USB interface 953 or another interface such as I²C, etc.).

In the example of FIG. 9, the LPC interface 970 provides for use of one or more ASICs 971, a trusted platform module (TPM) 972, a super I/O 973, a firmware hub 974, BIOS support 975 as well as various types of memory 976 such as ROM 977, Flash 978, and non-volatile RAM (NVRAM) 979. With respect to the TPM 972, this module may be in the form of a chip that can be used to authenticate software and hardware devices. For example, a TPM may be capable of performing platform authentication and may be used to verify that a system seeking access is the expected system.

The system 900, upon power on, may be configured to execute boot code 990 for the BIOS 968, as stored within the SPI Flash 966, and thereafter processes data under the control of one or more operating systems and application software (e.g., stored in system memory 940). An operating system may be stored in any of a variety of locations and accessed, for example, according to instructions of the BIOS 968. As an example, an information handling system, which can be a device (e.g., an apparatus), may include fewer or more features than shown in the system 900 of FIG. 9.

### Conclusion

Although examples of methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

What is claimed is:

1. An apparatus comprising:
a processor;
memory accessible by the processor; and
a display housing, a keyboard housing and a hinge assembly that rotatably couples the display housing and the keyboard housing wherein the keyboard housing comprises
a hinge assembly end, a front end, a left side and a right side;
a keyboard that comprises a spacebar, an S key, an L key and an S-to-L key distance; and
a touchpad disposed between the spacebar and the front end that extends a left side to right side distance greater than the S-to-L key distance.

2. The apparatus of claim 1 comprising palm rejection circuitry operatively coupled to the touchpad.

3. The apparatus of claim 1 comprising gesture recognition circuitry operatively coupled to the touchpad.

4. The apparatus of claim 3 wherein the gesture recognition circuitry comprises multi-touch gesture recognition circuitry.

5. The apparatus of claim 1 wherein the touchpad comprises a left palm rest portion and a right palm rest portion.

6. The apparatus of claim 3 wherein the gesture recognition circuitry comprises palm-based gesture recognition circuitry.

7. The apparatus of claim 6 wherein the palm-based gesture recognition circuitry comprises a library that comprises a palm-based horizontal slide gesture and a palm-based vertical slide gesture.

8. The apparatus of claim 6 wherein the palm-based gesture recognition circuitry comprises a library that comprises at least one dual palm-based gesture.

9. The apparatus of claim 1 wherein the spacebar comprises a spacebar width and wherein the touchpad comprises a left to right distance greater than the spacebar width.

10. The apparatus of claim 1 wherein the keyboard comprises a left side shift key, a right side shift key and a left side shift key to a right side shift key distance and wherein the touchpad extends a left side to right side distance greater than the left side shift key to a right side shift key distance.

11. A method comprising:
rejecting a static palm signal generated via a touchpad of a keyboard housing that comprises a keyboard wherein the signal is generated from an area of the touchpad which extends beyond an S key of the keyboard if originating from a touchpad side associated with the S key, and wherein the signal is generated from an area of the touchpad which extends beyond an L key of the keyboard if originating from a touchpad side associated with the L key;
detecting a dynamic touch signal generated via the touchpad; and
responsive to the dynamic touch signal, issuing a command.

12. The method of claim 11 wherein the dynamic touch signal corresponds to a dynamic finger touch signal associated with a finger sized area.

13. The method of claim 11 wherein the dynamic touch signal corresponds to a dynamic palm touch signal associated with a palm sized area.

14. The method of claim 11 wherein the dynamic touch signal corresponds to a dynamic palm gesture signal and wherein the command comprises a scroll command.

15. The method of claim 11 wherein the dynamic touch signal corresponds to a first dynamic palm gesture signal generated via the area of the touchpad side associated with the S key and a second dynamic palm gesture signal generated via the area of the touchpad side associated with the L key.

16. The method of claim 11 wherein the dynamic touch signal corresponds to a thumb touch signal associated with a central portion of the touchpad.

17. The method of claim 16 wherein the dynamic touch signal corresponds to a multiple thumb touch signal associated with the central portion of the touchpad.

18. One or more computer-readable media comprising computer-executable instructions to instruct a computer to:
reject a static palm signal generated via a touchpad of a keyboard housing that comprises a keyboard wherein the signal is generated from an area of the touchpad which extends beyond an S key of the keyboard if originating from a touchpad side associated with the S key, and wherein the signal is generated from an area of the touchpad which extends beyond an L key of the keyboard if originating from a touchpad side associated with the L key;
detect a dynamic touch signal generated via the touchpad; and
responsive to the dynamic touch signal, issue a command.

19. The one or more computer-readable media of claim 18 wherein the computer-executable instructions comprise instructions to instruct the computer to reject a static palm signal generated via the area of the touchpad side associated with the S key and to detect a dynamic touch signal generated via the area of the touchpad side associated with the L key.

20. The one or more computer-readable media of claim 18 wherein the computer-executable instructions comprise instructions to instruct the computer to reject a static palm signal generated via the area of the touchpad side associated with the L key and to detect a dynamic touch signal generated via the area of the touchpad side associated with the S key.
